(19) United States
(12) Patent Application Publication
(10) Pub. No.: US 2002/0077950 A1
(43) Pub. Date: Jun. 20, 2002

(54) Artificial intellectual stock ordering system and method

(75) Inventors: Wen-Chih Chen, Tainan (TW); Hung-Sheng Chiu, Taipei Hsien (TW)

Correspondence Address: DARBY & DARBY P.C., 805 Third Avenue, New York, NY, 10022, US

(73) Assignee: Institute for Information Industry

(21) Appl. No.: 09/780,240

(22) Filed: Feb. 9, 2001

(30) Foreign Application Priority Data
Dec. 18, 2000 (TW) 89127080

(51) Int. Cl. G06F 17/60

(52) U.S. Cl. 705/36

(57) ABSTRACT

The present invention discloses an artificial intellectual stock ordering system and method suited to a stock ordering process, comprising an input unit for inputting transaction conditions; an ordering computer coupled with the input unit, receiving the transaction conditions, and retrieving, analyzing and classifying a news document, assigning the news document with a grade, and outputting stock ordering information for ordering a stock purchase or sale, while the transaction conditions are matched and the grade is larger than a high value, or while the transaction conditions are matched and the grade is smaller than a low value; an electronic news computer connected to the ordering computer through a first network suited to provide the news document; and a security company computer connected to the ordering computer through a second network suited to receive the stock ordering information to buy or sell a stock.

### BACKGROUND OF THE INVENTION

1. Field of the Invention

The present invention relates to an artificial intellectual stock ordering system and method, and more particularly to an automated artificial intellectual stock ordering system which combines an ordering system and artificial intelligence for analysis and classification of the news documents.

2. Description of the Related Art

In recent years, the Internet has been widely developed, and most of the security companies provide electronic stock ordering systems on the Internet. However, almost all the ordering systems need to be operated manually by the investors during the transaction time.

In addition, investors may keep a different attitude about risk-pursuing or risk-avoiding in stock investment, but it is likely for most people to have specific reasons for their investments instead of randomized transactions in the stock market. Generally, an investor decides to make stock transactions, and the amount and price thereof, according to the results of news analysis, such as technical, financial and political news.

### SUMMARY OF THE INVENTION

Therefore, it is an object of the present invention to provide an artificial intellectual stock ordering system and method, and with the system the investors can determine transaction conditions for buying or selling the stocks, and the amount and price thereof. Then, the system will analyze and classify the news comprising technical, financial and political news documents, and automatically order a stock when the conditions are matched and the analysis shows good news.

The present invention discloses an artificial intellectual stock ordering system suited to a stock ordering process, comprising an input unit for inputting transaction conditions; an ordering computer coupled with the input unit, receiving the transaction conditions, and retrieving, analyzing and classifying a news document, assigning the news document with a grade, and outputting stock ordering information for ordering a stock purchase or sale, while the transaction conditions are matched and the grade is larger than a high value, or while the transaction conditions are matched and the grade is smaller than a low value; an electronic news computer connected to the ordering computer through a first network suited to provide the news document; and a security company computer connected to the ordering computer through a second network suited to receive the stock ordering information to buy or sell a stock.

The present invention further discloses an artificial intellectual stock ordering method, suited to a system comprising an input unit, an ordering computer, an electronic news computer and a security company computer, the method comprising the steps of: inputting transaction conditions and retrieving a news document of the electronic news computer via a first network to the ordering computer; analyzing the news document with a document analyzing method; classifying the news document to a document class; assigning a grade to the news document according to the document class thereof; and ordering a stock purchase or sale via a second network while the transaction conditions are matched and the grade is larger than a high value, or while the transaction conditions are matched and the grade is smaller than a low value.

### BRIEF DESCRIPTION OF THE DRAWINGS

The present invention can be more fully understood by reading the subsequent detailed description in conjunction with the examples and references made to the accompanying drawings, wherein:

FIG. 1 shows a block chart showing an artificial intellectual stock ordering system of the present invention; and

FIG. 2 shows a flow chart showing process of an artificial intellectual stock ordering method of the present invention.

### DETAILED DESCRIPTION OF THE PREFERRED EMBODIMENT

The present invention discloses an artificial intellectual stock ordering system and method, wherein the system would order a stock transaction according to transaction conditions determined by the investor and news analysis by the system.

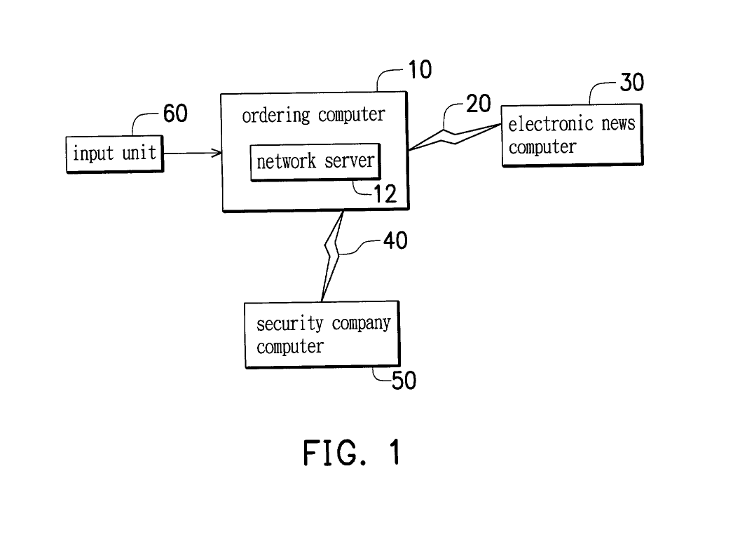

FIG. 1 shows a block chart showing the AI stock ordering system. As shown in FIG. 1, the system of the invention comprises an input unit 60, an ordering computer 10, an electronic news computer 30 and a security company computer 50. The input unit 60 may be a keyboard, a mouse, or any other form of input device. The ordering computer 10 is coupled to the input unit 60 and can be any type of computer systems or servers, wherein the ordering computer 10 has a network server 12. The ordering computer 10 and the electronic news computer 30 are connected with a first network 20, and the ordering computer 10 and the security company computer 50 are connected with a second network 40. The first network 20 and the second network 40 can be the Internet, LAN, WAN or any other form of network.

The input unit 60 of the embodiment is suited to input the transaction conditions. The ordering computer 10 coupled to the input unit 60 receives the transaction conditions, retrieves a news document from the electronic news computer 30, analyzes and classifies the news document, and assigns a grade to the news document. While the transaction conditions are matched, and the grade is larger than a high value or smaller than a low value, the ordering computer 10 sends stock ordering information to buy or sell a stock to the security company computer. The electronic news computer 30 is connected to the ordering computer 10 via the first network 20, providing news documents for the ordering computer to analyze and classify. The security company computer 50 is connected to the ordering computer 10 via the second network 40, receiving the stock ordering information to buy or sell a stock.

It should be noted that in order to simplify the case, as shown in FIG. 1, only one electronic news computer 30 and one security company computer 50 are in the system of the embodiment. However, the system is not limited therein and may include a plurality of electronic news computers 30 or a plurality of security company computers 50.

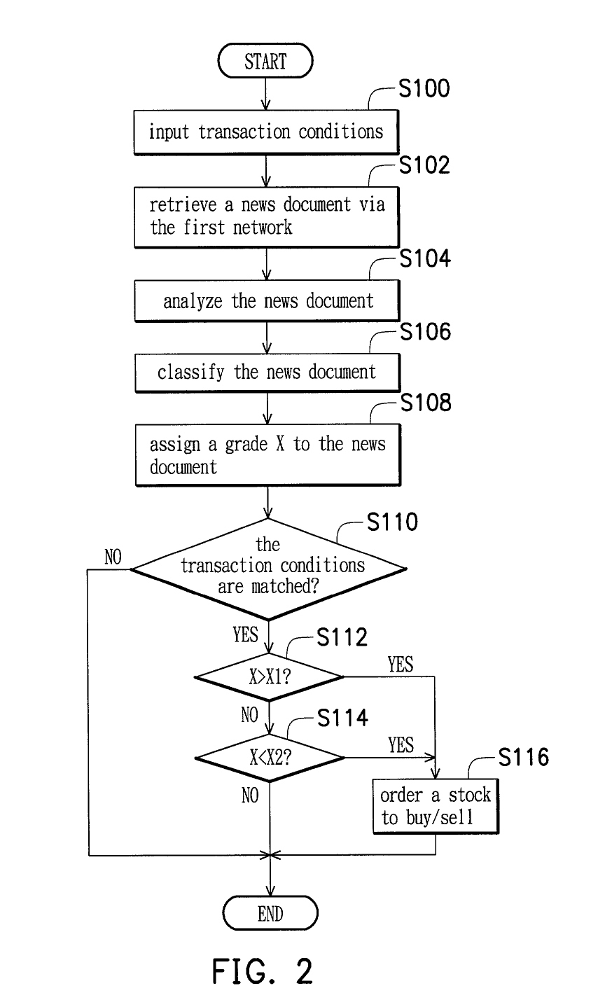

Next, the artificial intellectual stock ordering method will be described as follows. FIG. 2 shows the flow chart of the stock ordering process of the method. First, the ordering computer 10 receives transaction conditions input with the input unit 60 as shown in step S100. The transaction conditions can be a set of indexes, such as a glossy index, an individual index, or an associated index.

Then, the ordering computer 10 retrieves a news document from the electronic news computer 30 via the first network 20 in step S102. The news document comprises a technical analysis document, a financial report document, and a political analysis document, and the electronic news computer 30 comprises a server with news documents saved therein. In the case involving the stock market investment in Taiwan, for example, the electronic news computer 30 can be the web server of China Times News, Kimo Financial News, Taiwan Stock Classroom, or any other Taiwan news web site.

Next, the ordering computer 10 starts to analyze the news document with a document analyzing method (step 104). The document analyzing method can be a machine learning method or a natural language analytical method.

The machine learning method is a pre-learning process. A large amount of documents are pre-classified and sent to the system creating the common rules within documents in different classes. With the pre-learning process, a new document can be classified by the system through judgement of these common rules. For example, documents of good news or bad news can be classified and sent to the system in order to find their respective rules; then the system may judge a news document to be good news or bad news according to these rules.

On the other hand, the natural language analytical method is a method of analysis and arrangement of human languages. The grammar rules of a language can be set in the system, and subjects, verbs, adjectives and adverbs of sentences in a document can be found with these rules. Thus, the system may judge the meaning of sentences and classify the entire document as its proper class.

With the above analyzing step S104, the ordering computer 10 classifies the news document to a document class according to the analyzing result (step 106). The document class comprises very good news, good news, indifferent news, bad news, and very bad news. For example, financial news such as “ChinaTrust Bank Rose by the Daily 7% Upward Limit” would be classified as good news to ChinaTrust Bank, and “Jobless Rate Expected to Exceed 4% Next Year” would be classified as bad news. And political news such as “Chaos Results from Disrespect for Constitution: Taipei Mayor” would be classified as indifferent news.

According to the document class to which the news document belongs, the ordering computer 10 assigns a grade X to the news document (step S108). Then, the ordering computer 10 judges the transaction conditions and compares the grade X with a predetermined high value X1 and a predetermined low value X2. If the transaction conditions are matched, and the grade X is larger than the high value X1 (step 112) or smaller than the low value X2 (step 114), the ordering computer 10 sends stock ordering information to the security company computer 50 via the second network 40 ordering a stock to buy or sell.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An artificial intellectual stock ordering system suited to deal with a stock ordering process, comprising:
an input unit for inputting transaction conditions;
an ordering computer coupled with the input unit, said ordering computer receiving the transaction conditions, and retrieving, analyzing and classifying news documents, assigning a grade to each news document, and outputting stock ordering information for ordering a stock purchase or sale, while the transaction conditions are matched and the grade is larger than a high value, or while the transaction conditions are matched and the grade is smaller than a low value;
an electronic news computer connected to the ordering computer through a first network suited to provide the news document; and
a security company computer connected to the ordering computer through a second network suited to receive the stock ordering information to buy or sell a stock.

2. The system as claimed in claim 1, wherein the input unit comprises a keyboard.

3. The system as claimed in claim 1, wherein the input unit comprises a mouse.

4. The system as claimed in claim 1, wherein the transaction conditions comprise a glossy index.

5. The system as claimed in claim 1, wherein the transaction conditions comprise an individual index.

6. The system as claimed in claim 1, wherein the transaction conditions comprise an associated index.

7. The system as claimed in claim 1, wherein the ordering computer comprises a network server.

8. The system as claimed in claim 1, wherein the first network and the second network consist of the Internet, LAN and WAN.

9. An artificial intellectual stock ordering method, suited to a system comprising an input unit, an ordering computer, an electronic news computer and a security company computer, the method comprising the steps of:
inputting transaction conditions from the input unit and retrieving a news document of the electronic news computer via a first network to the ordering computer;
analyzing the news document with a document analyzing method;
classifying the news document to a document class;
assigning a grade to the news document according to the document class thereof; and
ordering a stock to buy or sell via a second network while the transaction conditions are matched and the grade is larger than a high value, or while the transaction conditions are matched and the grade is smaller than a low value.

10. The method as claimed in claim 9, wherein the electronic news computer comprises a server with news documents saved therein.

11. The method as claimed in claim 9, wherein the news document comprises a technical report document, a financial report document, and a political analysis document.

12. The method as claimed in claim 9, wherein the document analyzing method is a machine learning method.

13. The method as claimed in claim 9, wherein the document analyzing method is a natural language analytical method.

14. The method as claimed in claim 9, wherein the document class comprises very good news, goo d news, indifferent news, bad news and very bad news.
